(19) United States
(12) Patent Application Publication
(10) Pub. No.: US 2016/0110555 A1
(43) Pub. Date: Apr. 21, 2016

(54) RESOURCE SHARING APPARATUS, METHOD, AND NON-TRANSITORY COMPUTER READABLE STORAGE MEDIUM THEREOF

(71) Applicant: Institute For Information Industry, Taipei (TW)

(72) Inventors: Yen-Hung KUO, Taipei City (TW); Yu-Lin JENG, Tainan City (TW); Tzu-Wei YEH, New Taipei City (TW); Guang-Yan ZHENG, Taichung City (TW); Jyun-Kai WU, Tainan City (TW)

(21) Appl. No.: 14/519,789

(22) Filed: Oct. 21, 2014

(51) Int. Cl. G06F 21/62; H04L 29/06

(52) U.S. Cl. CPC G06F 21/62; H04L 63/10; G06F 2221/2145

(57) ABSTRACT

A resource sharing apparatus and a resource sharing method thereof are provided. The resource sharing apparatus runs a federated resource sharing program to execute a resource sharing method. The resource sharing apparatus can share a selected resource with a remote resource sharing apparatus via a share link of the selected resource, and the remote resource sharing apparatus can create an access point to access the selected resource stored in the resource sharing apparatus according to the share link.

### FIELD

The present invention relates to a resource sharing apparatus, method, and non-transitory computer readable storage medium thereof. Specifically, the present invention provides a resource sharing mechanism. By the resource sharing mechanism, two separate resource sharing apparatus which belong to different systems can access the resources of each other via share links.

### BACKGROUND

With the advancement of network technologies in recent years, various network applications have been developed to satisfy the overwhelming demand for file sharing, file transferring and the like. In general, the network architectures used in modern network applications include the client-server network architecture, the peer-to-peer (P2P) network architecture, and a hybrid of the client-server network and P2P network architectures. The P2P network architecture may have the advantage of no central server; however, it offers almost no security, and the resources shared in the P2P network architecture are usually read only. By contrast, although the client-server network architecture always has a central server, it is much more stable, flexible, and secure, and offers various operations on the resources (e.g., a read operation, a write operation, an execute operation, etc.).

Currently, several organizations or companies provide cloud storage services for their employees/registered users to store their files and share the files and/or folders with other people. The registered users resided in the same cloud storage system can share their files or folders with each other, and the shared files or folders can have different permissions for different users by according to different sharing purposes. However, since different cloud storage systems are independent and do not cooperate with each other, the registered users of the different cloud storage systems cannot directly share their files or folders with each other like in a cloud storage system. Under this circumstance, people need to register their own accounts in several cloud storage systems, and then upload the files or folders to the corresponding cloud storage system to share files or folders to people in the same cloud storage system. It is inconvenient when different people residing at different cloud storage systems try to share files or folders with each other.

According to the above descriptions, an urgent need exists in the art to provide a resource sharing mechanism for different cloud storage systems to make resources of different cloud storage systems accessible to each other.

### SUMMARY

An objective of the present invention includes providing a resource sharing mechanism for different resource sharing apparatus to access the resources of each other via the share links. By the resource sharing mechanism of the prevent invention, people can directly share files or folders stored in one cloud storage system to other people reside at another cloud storage system. As a result, the present invention allows users to share resources of different cloud storage systems in a more convenient way, and make more efficient use of the resources of these cloud storage systems.

To achieve the aforesaid objective, certain embodiments of the present invention include a resource sharing apparatus. The resource sharing apparatus comprises a storage medium, a network interface and a processor. The storage medium is configured to store a management system and a plurality of resources. The network interface is connected to a network. The processor is electrically connected to the storage medium and the network interface, and configured to run a federated resource sharing program installed in the management system. The federated resource sharing program is configured to: receive a share request associated with an internal user account of the resource sharing apparatus for sharing a selected resource of the resources with an external user account of a remote resource sharing apparatus; create a share link of the selected resource according to the share request; generate a share message with the share link and the external user account; and transmit the share message to the remote resource sharing apparatus via the network interface so that the remote resource sharing apparatus creates an access point for the external user account according to the share message.

In addition, certain embodiments of the present invention include a resource sharing method for use in a resource sharing apparatus. The resource sharing apparatus comprises a storage medium, a network interface and a processor. The storage medium stores a management system and a plurality of resource. The processor runs a federated resource sharing program installed in the management system to execute the resource sharing method, and the resource sharing method comprises the following steps of: receiving a share request associated with an internal user account of the resource sharing apparatus for sharing a selected resource of the resources with an external user account of a remote resource sharing apparatus; creating a share link of the selected resource according to the share request; generating a share message with the share link and the external user account; and transmitting the share message to the remote resource sharing apparatus via the network interface so that the remote resource sharing apparatus creates an access point for the external user account according to the share message.

Besides, certain embodiments of the present invention include a non-transitory computer readable storage medium having a federated resource sharing program stored therein. The federated resource sharing program executes a resource sharing method after being loaded into a resource sharing apparatus and installed in a management system of the resource sharing apparatus. The resource sharing apparatus is connected to a network. The resource sharing method comprising the following steps of: receiving a share request associated with an internal user account of the resource sharing apparatus for sharing a selected resource of the resources with an external user account of a remote resource sharing apparatus; creating a share link of the selected resource according to the share request; generating a share message with the share link and the external user account; and transmitting the share message to the remote resource sharing apparatus via the network interface so that the remote resource sharing apparatus creates an access point for the external user account according to the share message.

Furthermore, in order to achieve the aforesaid objective, certain embodiments of the present invention include a resource sharing apparatus. The resource sharing apparatus comprises a storage medium, a network interface and a processor. The storage medium is configured to store a management system. The network interface is connected to a network. The processor is electrically connected to the storage medium and the network interface, and configured to run a federated resource sharing program installed in the management system. The federated resource sharing program is configured to: receive a share message with a share link and an internal user account from the remote resource sharing apparatus, wherein the share link is created for sharing a selected resource stored in the remote resource sharing apparatus and associated with an external user account of the remote resource sharing apparatus; and create an access point for the internal user account according to the share message.

In addition, certain embodiments of the present invention include a resource sharing method for use in a resource sharing apparatus to achieve the aforesaid objective. The resource sharing apparatus comprises a storage medium, a network interface and a processor. The storage medium stores a management system. The processor runs a federated resource sharing program installed in the management system to execute the resource sharing method, and the resource sharing method comprising the following steps of: receiving a share message with a share link and an internal user account from the remote resource sharing apparatus, wherein the share link is created for sharing a selected resource stored in the remote resource sharing apparatus and associated with an external user account of the remote resource sharing apparatus; and creating an access point for the internal user account according to the share message.

Besides, certain embodiments of the present invention include a non-transitory computer readable storage medium having a federated resource sharing program stored therein. The federated resource sharing program executes a resource sharing method after being loaded into a resource sharing apparatus and installed in a management system of the resource sharing apparatus. The resource sharing apparatus is connected to a network. The resource sharing method comprising the following steps of: receiving a share message with a share link and an internal user account from the remote resource sharing apparatus, wherein the share link is created for sharing a selected resource stored in the remote resource sharing apparatus and associated with an external user account of the remote resource sharing apparatus; and creating an access point for the internal user account according to the share message.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view illustrating how a resource sharing apparatus RSA1 shares resource with a resource sharing apparatus RSA2 in accordance with the first embodiment to the fourth embodiment of the present invention;

FIG. 1B is a schematic view of the resource sharing apparatus RSA1 and the resource sharing apparatus RSA2 in accordance with the first embodiment to the fourth embodiment of the present invention;

FIG. 2 is a schematic view of a share record of the present invention.

FIG. 3A and FIG. 3B respectively depict two scenarios in accordance with the fourth embodiment of the present invention;

FIG. 4A and FIG. 4B are schematic views illustrating a graphic user interface GUI_1 of the resource sharing apparatus RSA1 in accordance with the fifth embodiment of the present invention;

FIG. 5A and FIG. 5B are schematic views illustrating a graphic user interface GUI_2 of the resource sharing apparatus RSA2 in accordance with the fifth embodiment of the present invention;

FIG. 6 is a schematic view illustrating how a mobile phone 61 shares resource with a smart refrigerator 63 in accordance with the sixth embodiment of the present invention;

FIG. 7 is a flowchart diagram illustrating a resource sharing method of a resource sharing apparatus in accordance with the seventh embodiment of the present invention; and

FIG. 8 is a flowchart diagram illustrating a resource sharing method of a resource sharing apparatus in accordance with the eighth embodiment of the present invention.

### DETAILED DESCRIPTION

The present invention includes a resource sharing apparatus, method, and non-transitory computer readable storage medium thereof. In the following descriptions, the invention will be explained with reference to certain example embodiments thereof. It shall be appreciated that theses example embodiments are not intended to limit the claimed invention to any specific examples, embodiments, environment, applications or implementations described in these embodiments. Therefore, the description of these example embodiments is only for purpose of illustration rather than to limit the invention and the scope claimed in this application shall be governed by the claims.

In the following embodiments and the attached drawings, elements unrelated to the present invention are omitted from depiction; and dimensional relationships among individual elements in the attached drawings are illustrated only for ease of understanding, but not to limit the actual scale.

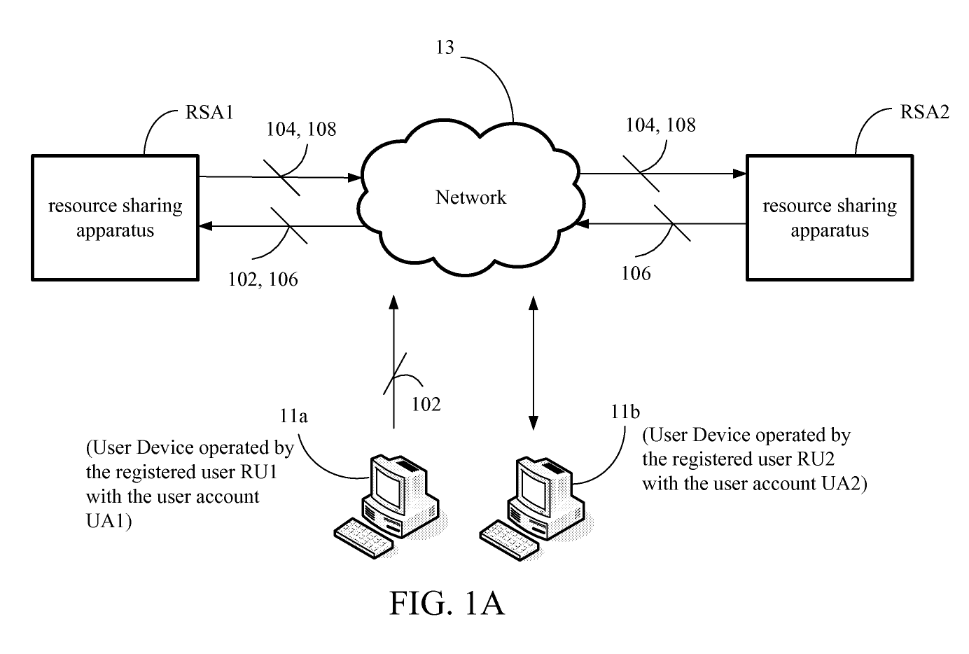

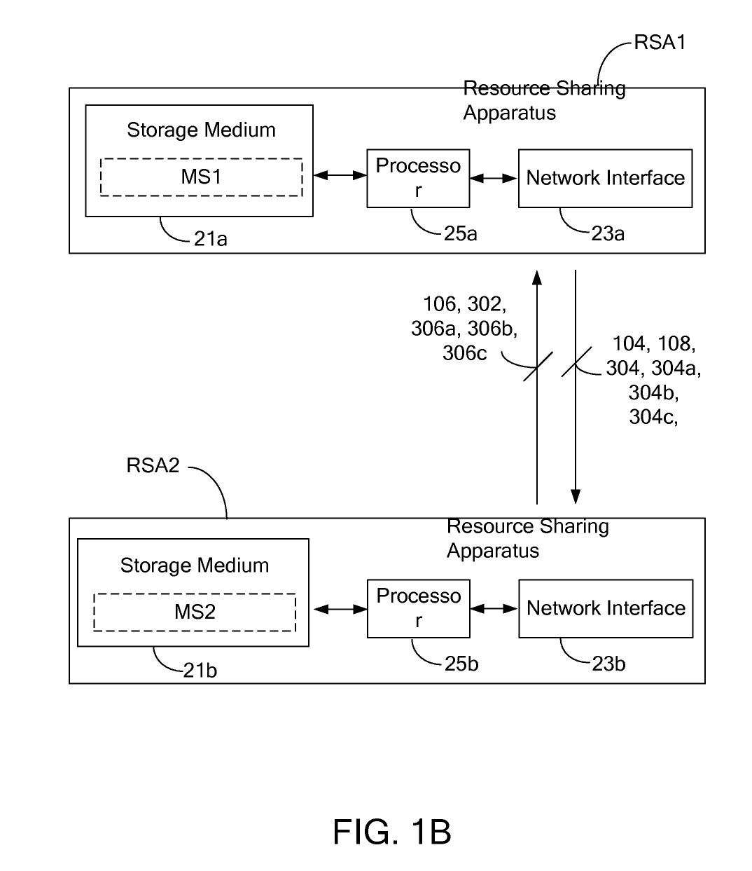

A first embodiment of the present invention is shown in FIG. 1A and FIG. 1B. FIG. 1A is a schematic diagram illustrating how a resource sharing apparatus RSA1 shares a specific resource with a resource sharing apparatus RSA2 in the present invention. FIG. 1B is a schematic diagram illustrating the resource sharing apparatus RSA1 and the resource sharing apparatus RSA2 of the present invention. For the resource sharing apparatus RSA1, the resource sharing apparatus RSA2 is a remote and separate resource sharing apparatus and managed by other organization or company. In other words, the resource sharing apparatus RSA1 and the resource sharing apparatus RSA2 individually provide their cloud storage services for their registered users. Moreover, the resource sharing apparatus RSA1 runs a management system MS1 with its own federated resource sharing program installed therein, and the resource sharing apparatus RSA2 runs a management system MS2 with its own federated resource sharing program installed therein. By their own federated resource sharing program, the resource sharing apparatus RSA1 and the resource sharing apparatus RSA2 could execute these operations as described below.

As shown in FIG. 1A, when a registered user RU1 of the resource sharing apparatus RSA1 would like to share a selected resource (e.g., a folder, a file or the like) with a registered user RU2 of the resource sharing apparatus RSA2, the registered user RU1 operates the user device 11a to access the resource sharing apparatus RSA1 and send a share request 102 to the resource sharing apparatus RSA1. The share request 102 carries the information of the internal user account UA1 (i.e. the user account of the registered user RU1), the selected sharing resource and the external user account UA2 (i.e. the user account of the registered user RU2).

After receiving the share request 102 associated with the user account UA1 for sharing the selected resource with the user account UA2, the resource sharing apparatus RSA1 creates a share link of the selected resource according to the share request 102. The share link of the selected resource is constructed based on the Hyper Text Transfer Protocol (HTTP), for example “https://url.domain/1A2B3C4D,” so that the resource sharing apparatus RSA2 could access the resource sharing apparatus RSA1 via the share link. It is noted that for the resource sharing apparatus RSA1, the user account UA1 is an “internal user account” and the user account UA2 is an “external user account”; conversely, for the resource sharing apparatus RSA2, the user account UA1 is an “external user account” and the user account UA2 is an “internal user account”.

Afterwards, the resource sharing apparatus RSA1 generates a share message 104 with the share link and the user account UA2, and transmits the share message 104 to the resource sharing apparatus RSA2 via the network 13. After receiving the share message 104 with the share link of the selected resource and the user account UA2 from the resource sharing apparatus RSA1, the resource sharing apparatus RSA2 creates an access point for the user account UA2 according to the share message 104. In this way, when the register user RU2 operates the user device 11b (e.g., personal computer) to access the resource sharing apparatus RSA2, the register user RU2 is able to access the selected resource of the resource sharing apparatus RSA1 via the access point. It is noted that the user device 11a and the user device 11b may be a personal computer, a handheld device, or any other user device with a network connection function.

In another embodiment, the registered user RU1 may set an access permission for the registered user RU2 to access the selected resource. In this case, the share request 102 further includes access permission information indicating permitted operations (e.g., a read operation, a write operation, an execute operation, etc.) for the registered user RU2. Therefore, the resource sharing apparatus RSA1 may create the share link further based on the access permission information. Besides, in another embodiment, the resource sharing apparatus RSA1 may further encrypts the share link by a passkey for the security purpose, and generates the share message 104 with the encrypted share link and the access permission information. Accordingly, the resource sharing apparatus RSA2 decrypts the share link by a corresponding passkey. For example, the share link of the selected resource could be encrypted by the public key of the user account UA2 of the resource sharing apparatus RSA2, and the encrypted share link could be decrypted by the private key of the user account UA2 of the resource sharing apparatus RSA2. Nevertheless, there are several encryption and decryption technologies applicable to encrypt and to decrypt the selected resource and these technologies have been well known by people skilled in this art; it therefore will not be further described herein.

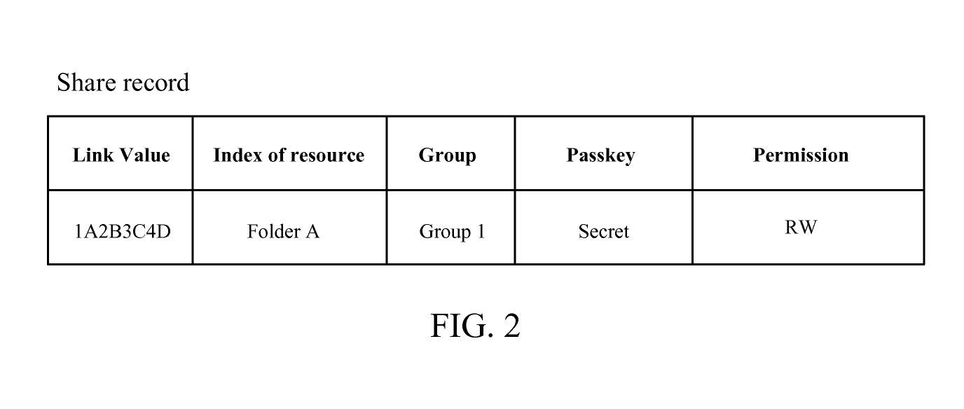

In other embodiments, the resource sharing apparatus RSA1 further creates a share record in a database installed in the management system running in the resource sharing apparatus RSA1 to record a link value of the share link, an index of the selected resource, the access permission information, and the passkey, as shown in FIG. 2. Specifically, the link value of a share link is unique and oriented to a specific resource, and the index of the resource indicates which resource (i.e. a folder, a file or a service) is oriented to. In this case, the resource sharing apparatus RSA1 creates the share link according to the share record.

In other embodiments, the resource sharing apparatus RSA1 further creates a group for the user account UA2 according to the share request 102 or another particular request from the user device 11a. In this case, the resource sharing apparatus RSA1 further records the group in the share record. Moreover, other user accounts of the resource sharing apparatus RSA2 or other resource sharing apparatus in the same group may have same permission to access the selected resource.

As shown in FIG. 1A, the resource sharing apparatus RSA2 further transmits an access request 106 to the resource sharing apparatus RSA1 via the network 13 to access the share link when the registered user RU2 operates the user device 11b to access the selected resource of the resource sharing apparatus RSA1 through the access point. After receiving the access request 106 via the network 13, the resource sharing apparatus RSA1 further determines whether an authentication of the access request 106 is passed.

If the authentication is passed, the resource sharing apparatus RSA1 accesses the selected resource and transmits a resource access response 108 to the resource sharing apparatus RSA2. For example, the access request 106 may request to get the selected resource (i.e. a file), and thus, the resource access response 108 contains the selected resource. Otherwise, if the authentication of the access request 106 is not passed, the resource access response 108 may contain relevant information to inform the resource sharing apparatus RSA2 of the access result (i.e. access failure). For example, the screen of the user device 11b may show a pop-up notification information window to inform the registered user UA2 of the access failure.

It shall be appreciated that the share request 102 and the access request 106 in the above description are created based on the operations of the registered user UA1 and the registered user UA2 respectively; however, such operations could be automatically executed by the resource sharing apparatus RSA1 and the resource sharing apparatus RSA2 themselves in some practical scenarios. For example, by presetting a share rule, any files uploaded to the resource sharing apparatus RSA1 by the user account UA1 would be automatically shared with the user account UA2 of the resource sharing apparatus RSA2, and the resource sharing apparatus RSA2 would automatically access the resource sharing apparatus RSA1 to get the copies of the files for the user account UA2.

A second embodiment of the present invention is also referred to FIG. 1B. The resource sharing apparatus RSA1 comprises a storage medium 21a, a network interface 23a and a processor 25a. The storage medium 21a stores the management system MS1 and a plurality of resources (e.g. folders, files, etc.) which may be created or uploaded by its registered users.

Specifically, the storage medium 21a may be a tangible machine-readable medium or a combination of multiple tangible machine-readable medium for providing the integration apparatus with a permanent storage, such as a flash memory, a hard disk, or any other storage media with the same function and well known to those skilled in the art. The network interface 23a is connected to the network 13. The processor 25a, electrically connected to the storage medium 21a and the network interface 23a, and the processor 25a further runs a federated resource sharing program installed in the management system MS1 to execute several operations as described below.

In concert with the first embodiment, the processor 25a receives the share request 102 associated with the user account UA1 of the resource sharing apparatus RSA1 for sharing the selected resource of the resources with the user account UA2 of the resource sharing apparatus RSA2. Then, the processor 25a creates the share link of the selected resource according to the share request 102, and generates the share message 104 with the share link and the user account UA2. Afterwards, the processor 25a transmits the share message 104 to the resource sharing apparatus RSA2 via the network interface 23a so that the resource sharing apparatus RSA2 creates the access point for the user account UA2 according to the share message 104.

After receiving the access request 106 to access the share link from the resource sharing apparatus RSA2 via the network interface 23a, the processor 25a of the resource sharing apparatus RSA1 determines whether the authentication of the access request 106 is passed. If the authentication of the access request 106 is passed, then the processor 25a accesses the selected resource and transmits a resource access response 108 to the resource sharing apparatus RSA2.

A third embodiment of the present invention is also referred to FIG. 1B. The resource sharing apparatus RSA2 comprises a storage medium 21b, a network interface 23b and a processor 25b. The storage medium 21b stores the management system MS2 and a plurality of resources. The network interface 23b is connected to the network 13. The processor 25b is electrically connected to the storage medium 21b and the network interface 23b, and configured to run a federated resource sharing program installed in the management system MS2 to execute several operations as described below.

In concert with the first embodiment, the processor 25b of the resource sharing apparatus RSA2 receives the share message 104 with the share link and the user account UA2 from the resource sharing apparatus RSA1. The share link is created for sharing the selected resource stored in the resource sharing apparatus RSA1 and associated with the user account UA1 of the resource sharing apparatus RSA1. Next, the processor 25b creates the access point for the user account UA2 according to the share message 104. Afterwards, the processor 25b further transmits the access request 106 to access the share link to the resource sharing apparatus RSA1 via the network interface 23b.

In another embodiment, when the share request 102 further includes access permission information, the processor 25a of the resource sharing apparatus RSA1 creates the share link according the access permission information. And, in another embodiment for security purpose, the processor 25a of the resource sharing apparatus RSA1 may further encrypt the share link by a passkey, and generates the share message 104 with the encrypted share link and the access permission information. In this case, the processor 25b of the resource sharing apparatus RSA2 would decrypt the share link by a corresponding passkey after receiving the share message 104.

Furthermore, in other embodiments, the processor 25a of the resource sharing apparatus RSA1 further creates a share record in the database installed in the management system MS1 to record the link value of the share link, an index of the selected resource, the access permission information, and the passkey. Accordingly, the processor 25a of the resource sharing apparatus RSA1 creates the share link according to the share record. Moreover, the processor 25a may further create a group for the user account UA2 according to the share request 102 or another particular request from the user device 11a, and record the group in the share record.

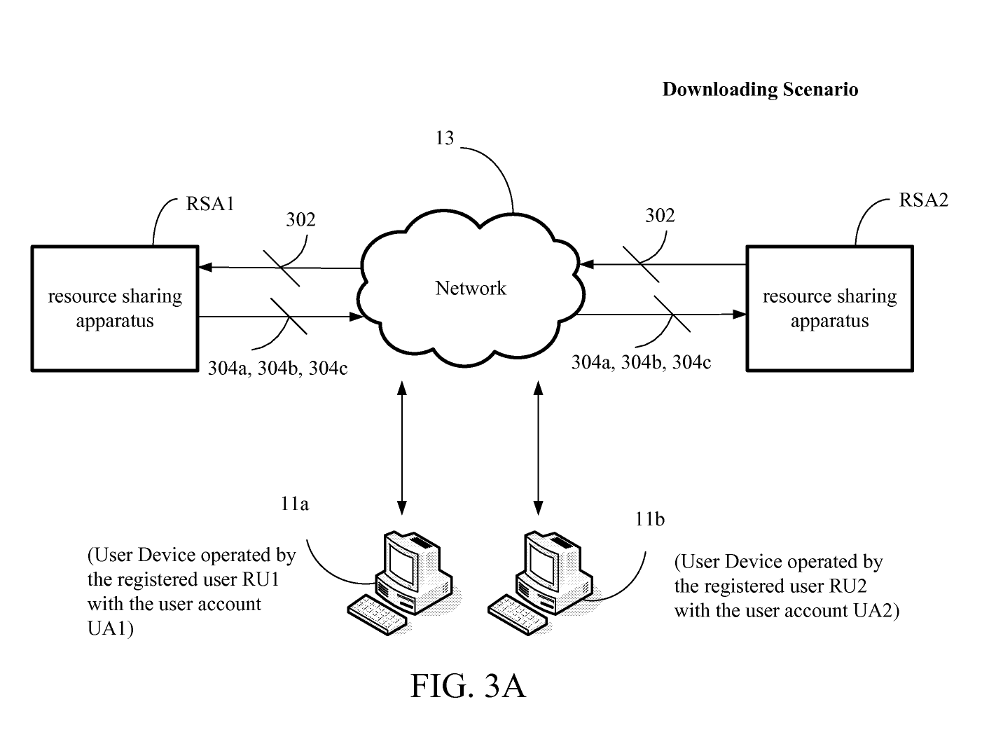

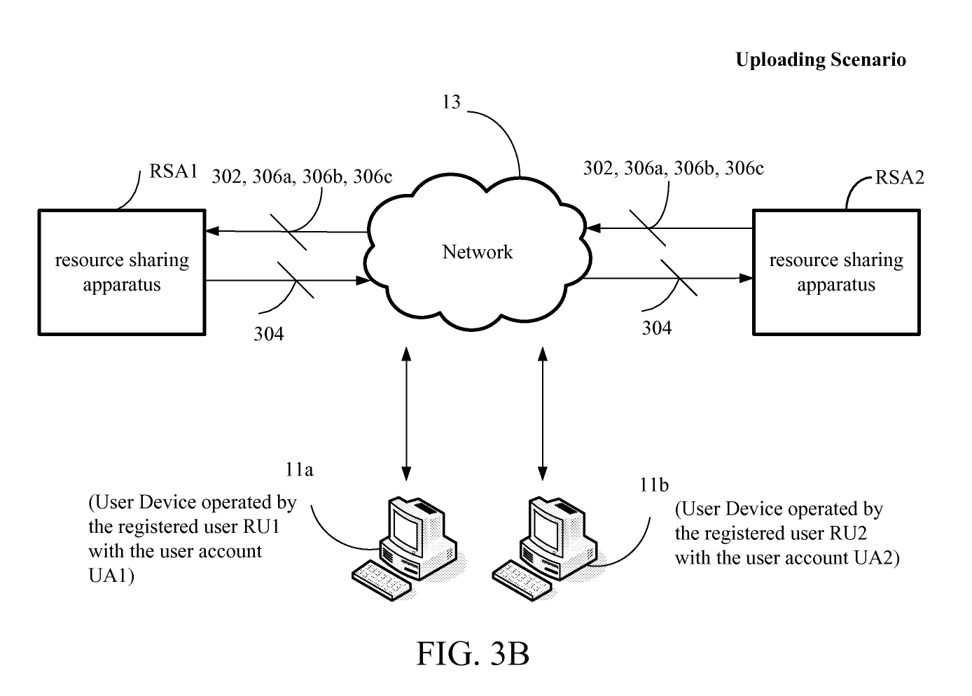

A fourth embodiment of the present invention is an extension of the first embodiment of the present invention and is shown in FIG. 3A and FIG. 3B. FIG. 3A and FIG. 3B depict an example how to transfer the resource between the resource sharing apparatus RSA1 and the resource sharing apparatus RSA2 in parallel to accelerate the transmission.

As shown in FIG. 3A, when the registered user RU2 operates the user device 11b to access the resource sharing apparatus RSA2 and request to transfer (i.e. download) the selected resource from the resource sharing apparatus RSA1 to the resource sharing apparatus RSA2, the resource sharing apparatus RSA2 may transmit a quick access request 302 instead of the access request 106 to the resource sharing apparatus RSA1 via the network 13. The quick access request 302 includes at least one temporary share link and at least one corresponding port number.

After receiving the quick access request 302, the resource sharing apparatus RSA1 determines whether an authentication of the quick access request 302 is passed. Next, the resource sharing apparatus RSA1 creates a file layout of the selected resource according to the quick access request 302 when the authentication is passed, and then transmits a plurality of quick access responses 304a, 304b, 304c with the file layout and the selected resource in parallel to the resource sharing apparatus RSA2 via the network 13 according to the share link created by the resource sharing apparatus RSA1, the temporary share links created by the resource sharing apparatus RSA2 and the port numbers corresponding to the share link and the temporary share links.

Specifically, on the presumption that the resource sharing apparatus RSA1 divides the selected resource into three parts, each of the quick access responses 304a, 304b, 304c may contain one part of the selected resource, respectively. In this case, the quick access responses 304a, 304b, 304c could be transmitted from the resource sharing apparatus RSA1 to the resource sharing apparatus RSA2 in parallel through different port number pairs. In other embodiments, the file layout could be transmitted individually to the resource sharing apparatus RSA2 by another quick access response; however, the scale and way of transmitting the file layout is not used to limit the scope of the present invention.

When the transmission of the selected resource is finished, the resource sharing apparatus RSA2 reconstructs the selected resource from the quick access responses according to the file layout. In addition, there may be one or more acknowledge messages transmitted between the resource sharing apparatus RSA1 and the resource sharing apparatus RSA2 for indicating the result of the transmission. It should be appreciated that, based on the above description, those of ordinary skill in the art can easily understand how the selected resource being transmitted via several quick access responses by using HTTP according to the share links and their corresponding port numbers; therefore, this will not be further described herein.

The above operations of the resource sharing apparatus RSA1 are executed by the processor 25a, while the above operations of the resource sharing apparatus RSA2 are executed by the processor 25b. More specifically, the processor 25a receives the quick access request 302 via the network interface 23a, determines whether the authentication of the quick access request 302 is passed, creates the file layout of the selected resource, and transmits the quick access responses 304a, 304b, 304c via the network interface 23a. On the other hand, the processor 25b transmits the quick access request 302 via the network interface 23b, receives the quick access responses 304a, 304b, 304c via the network interface 23b, and reconstructs the selected resource.

In another scenario as shown in FIG. 3B, when the registered user RU2 operates the user device 11b to access the resource sharing apparatus RSA2 and request to transfer (i.e. upload) a specific resource from the resource sharing apparatus RSA2 to the resource sharing apparatus RSA1, the resource sharing apparatus RSA2 transmits the quick access request 302 to the resource sharing apparatus RSA1 via the network 13. The quick access request 302 includes the file layout of the specific resource. Specifically, the resource sharing apparatus RSA2 also can divide the specific resource into several parts and create the file layout based on the division.

Similarly, after receiving the quick access request 302 from the resource sharing apparatus RSA2, the resource sharing apparatus RSA1 determines whether the authentication of the quick access request 302 is passed. If the authentication of the quick access request 302 is passed, the resource sharing apparatus RSA1 transmits a quick access response 304 with at least one temporary share link and at least one corresponding port number to the resource sharing apparatus RSA2 via the network 13 so as to indicate that the transferring of the specific resource stored in the resource sharing apparatus RSA2 is permitted.

Next, the resource sharing apparatus RSA2 transmits a plurality of upload messages 306a, 306b, 306c with the specific resource in parallel to the resource sharing apparatus RSA1 according to the share link, the temporary share links and the port numbers corresponding to the share link and the temporary share links. When the transmission of the specific resource is finished, the resource sharing apparatus RSA1 reconstructs the specific resource from the upload message 306a, 306b, 306c according to the file layout. Similarly, there may be one or more acknowledge messages transferred between the resource sharing apparatus RSA1 and the resource sharing apparatus RSA2 for indicating the result of the transmission.

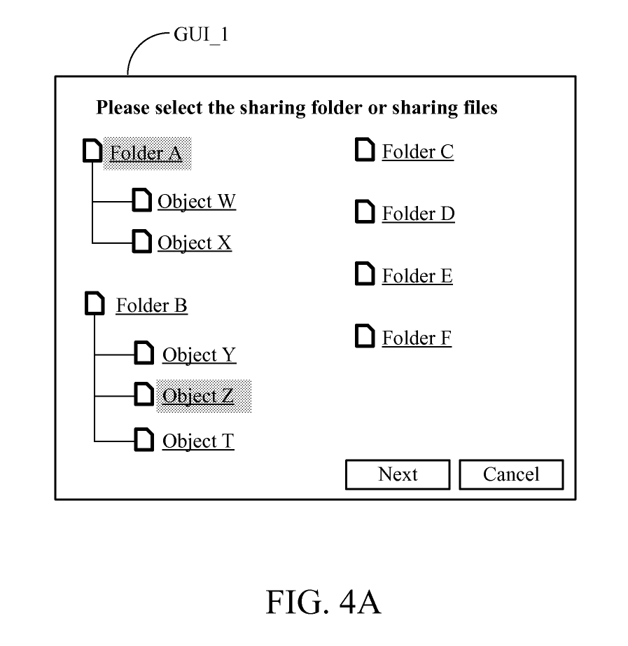

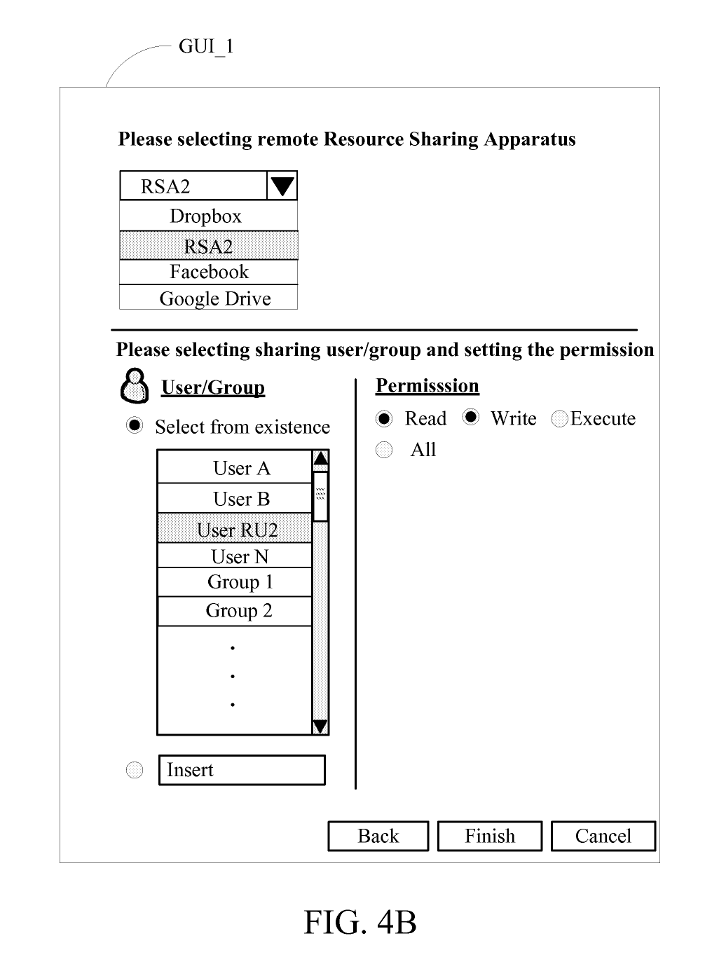

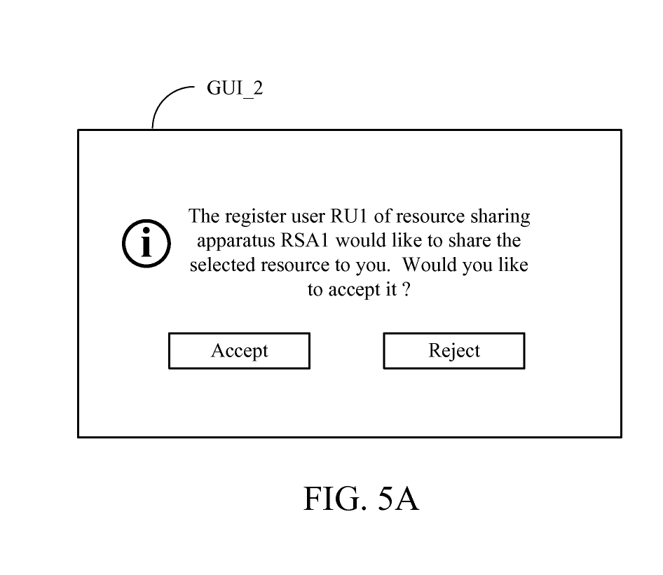

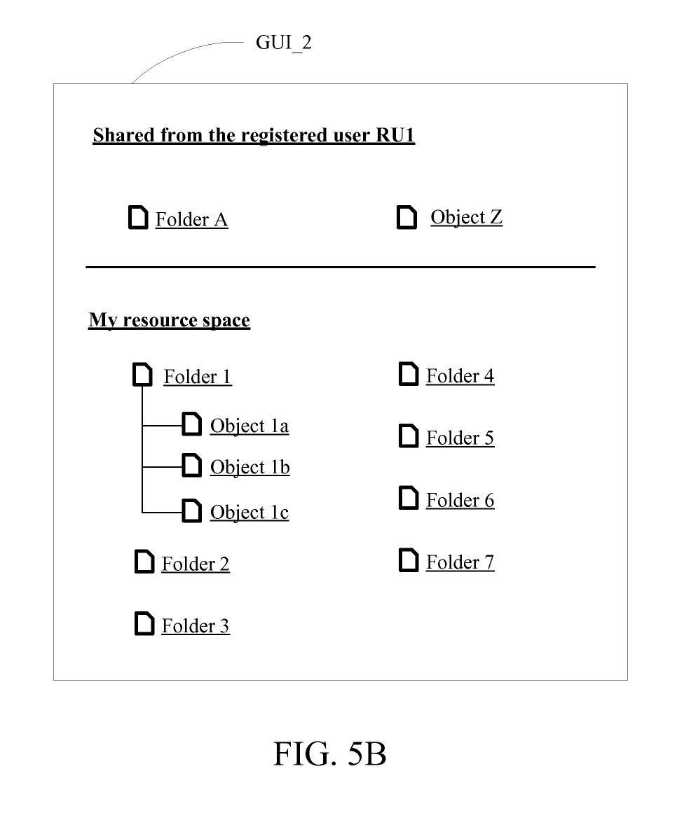

The fifth embodiment of the present invention is depicted in FIGS. 4A-4B and FIGS. 5A-5B, which depict an example to implement the present invention. FIG. 4A and FIG. 4B show a graphic user interface GUI_1 provided by the management system MS1 of the resource sharing apparatus RSA1 when running the federated resource sharing program. By the graphic user interface GUI_1, the registered user RU1 of the resource sharing apparatus RSA1 could operate the management system MS1 through the federated sharing program to achieve the operations as described in the previous embodiments.

FIG. 4A shows a page of the graphic user interface GUI_1 displayed on the screen of the user device 11a. On this page, the register user RU1 could select the resource and share it with other users. For example, the register user RU1 selects the Folder A and the Object Z by clicking corresponding positions on GUI_1 and then click the “Next” button to finish the selection of the resource to be shared. Besides, the register user RU1 may click the “Cancel” button to cancel this sharing action.

After clicking the “Next” button, the graphic user interface GUI_1 turns into anther page as shown in FIG. 4B for the registered user RU1 to select the remote resource sharing apparatus, its registered user/group and related parameter. On this page, the registered user RU1 selects resource sharing apparatus RSA2 as the share destination and the registered user RU2 as the share target. Besides, if the registered user RU1 cannot find a specific user/group from the existence (i.e. the insertion history) to share with, there is an insertion option for insert the user account of the specific user or the group name. In addition, the registered user RU1 may further select other user or group as one of the share targets on this page; that is, multiple users or groups could be selected at once. After selecting the share target (i.e. the register user RU2), the registered user RU1 may further set the permission for the register user RU2. Once the setting is completed, the registered user RU1 could click “Finish” button and the share request 102 is sent to the resource sharing apparatus RSA1. Similarly, the register user RU1 may also click the “Cancel” button to cancel this sharing action in this stage, or click the “Back” button to the previous page to reselect the sharing resource.

As mentioned earlier, the above actions could be preset, and it will automatically executed by the resource sharing apparatus RSA1 to share the newly uploaded or created resources to the specific registered user of a remote resource sharing apparatus. Since those of ordinary skill in the art can easily understand how to automatically share the resource by presetting, this will not be further described herein.

Now referring to FIG. 5A and FIG. 5B, a graphic user interface GUI_2 provided by the management system MS2 of the resource sharing apparatus RSA2 when running the federated resource sharing program is exemplarily presented. After receiving the share message 104, the graphic user interface GUI_2 of the resource sharing apparatus RSA2 will create a notification information and show it on the screen of the user device 11b when the register user RU2 operates the user device 11b to access the resource sharing apparatus RSA2.

The notification information could be presented by a pop-up window as shown in FIG. 5A. By the pop-window, the registered user could learn about the relevant information, and determine whether to accept the selected resource by the option buttons thereon. In this case, the register user RU2 may click the “Accept” button to accept the selected resource. Instead, the register user RU2 may click the “Reject” button to refuse the selected resource.

In the case that the registered user RU2 has accepted the selected resource by clicking the “Accept” button, the graphic user interface GUI_2 would be turned into another page as shown in FIG. 5B. The resource sharing apparatus creates the access points for the selected resources (i.e., the Folder A and the Object Z), and shows them on the graphic user interface GUI_2. Thus, the register user RU2 could operate the graphic user interface GUI_2 to access the Folder A and the Object Z stored in the resource sharing apparatus RSA1 via the access points.

In other embodiment, the register user RU2 can drag the selected resources (i.e., the Folder A and the Object Z) to his/her own resource space to change the positions of the access points shown on the graphic user interface GUI_2. However, in another embodiment, if the register user RU2 would like to download the selected resources (i.e., the Folder A and the Object Z) to his/her own resource space, he or she could copy the “Folder A” or the “Object Z” to his/her specific resource space. By this way, the operations described in the fourth embodiment may be executed to accelerate the transmission.

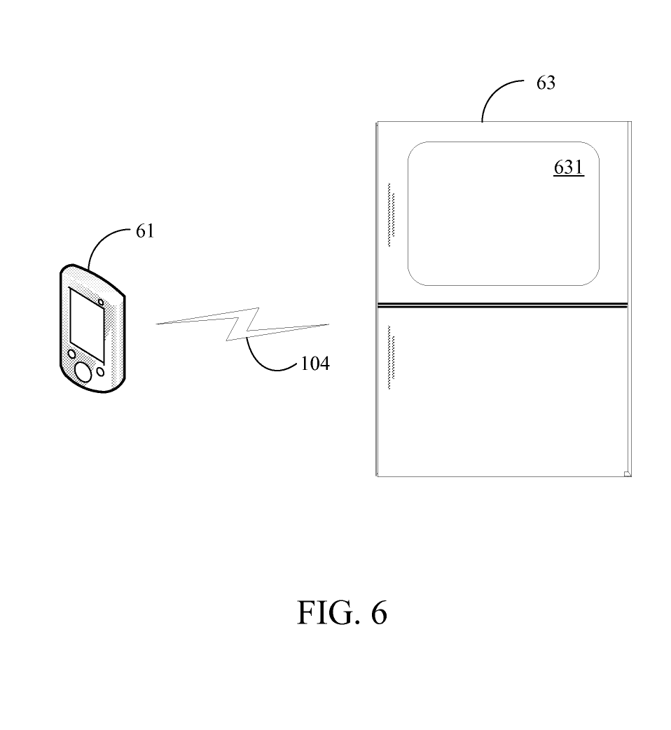

The sixth embodiment of the present invention is depicted in FIG. 6 which depicts another example to implement the present invention. In this embodiment, the functions of the user device 11a are integrated into the resource sharing apparatus RSA1 as a mobile phone 61, and the functions of the user device 11b are integrated into the resource sharing apparatus RSA2 as a smart refrigerator 63. Both the mobile phone 61 and the smart refrigerator 63 are connected to the network (i.e. the Internet or the personal area network), and they could detect and connect to each other.

In this case, if a user would like to share a file (e.g., a recipe file) with the smart refrigerator 63, he or she operates the mobile phone 61 to send the share message 104 to the smart refrigerator 63. After receiving the share message 104, the smart refrigerator 63 may automatically accept the share message 104 and create an access point on its graphical user interface. In addition, the smart refrigerator 63 may further automatically download the file from the mobile phone 61 by the access point. Therefore, when the user operates the smart refrigerator 63, he or she could get the recipe on the screen 631 of the smart refrigerator 63.

It is noted that this embodiment takes the mobile phone 61 and the smart refrigerator 63 as the examples; however, those of ordinary skill in the art can easily appreciate that the present invention can be applied to Internet of Things (IoT). The Things having a network connection function could implement the present invention, and are within the scope of the present invention.

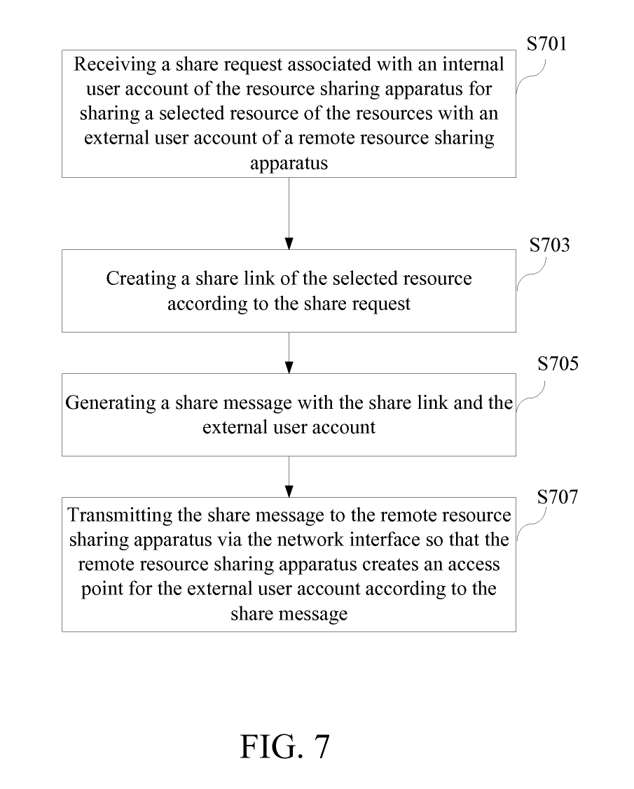

The seventh embodiment of the present invention is a resource sharing method, a flow chart of which is shown in FIG. 7. The resource sharing method of this embodiment can be applied to the resource sharing apparatus (e.g., the resource sharing apparatus RSA1) in all the aforesaid embodiments. The resource sharing apparatus comprises a storage medium, a network interface and a processor. The storage medium stores a management system and a plurality of resource, and the processor runs a federated resource sharing program installed in the management system to execute the resource sharing method.

Firstly, step S701 is executed to receive a share request associated with an internal user account of the resource sharing apparatus for sharing a selected resource of the resources with an external user account of a remote resource sharing apparatus. Specifically, the remote resource sharing apparatus is independent of the resource sharing apparatus. Next, step S703 is executed to create a share link of the selected resource according to the share request. Then, the processor further generates a share message with the share link and the external user account in step S705. Thereafter, step S707 is executed to transmit the share message to the remote resource sharing apparatus via the network interface so that the remote resource sharing apparatus creates an access point for the external user account according to the share message.

In other embodiments, the share request further includes access permission information. In this case, the resource sharing method further comprises the following steps of: creating the share link according the access permission information; encrypting the share link by a passkey; and generating the share message with the encrypted share link and the access permission information.

In addition, in other embodiments, the resource sharing method can further comprises the following steps of: creating a share record in a database installed in the management system to record a link value of the share link, an index of the selected resource, the access permission information, and the passkey; and creating the share link according to the share record. Furthermore, in some other embodiments, the resource sharing method further comprises the following steps of: creating a group containing the external user account; and recording the group in the share record.

In another embodiment that the selected resource is accessed via the share link, the resource sharing method further comprise the following steps of: receiving an access request from the remote resource sharing apparatus via the network interface to access the share link; determining whether an authentication of the access request is passed according to the share record; accessing the selected resource when the authentication is passed; and transmitting a resource access response to the remote resource sharing apparatus. In this embodiment, resources could be accessible to the remote resource sharing apparatus under security authentication.

Additionally, in another embodiment that an acceleration of transmission is needed, the resource sharing method further comprise the following steps of: receiving a quick access request from the remote resource sharing apparatus via the network interface to access the share link for downloading the selected resource, wherein the quick access request includes at least one temporary share link and at least one corresponding port number; determining whether an authentication of the quick access request is passed according to the share record; creating a file layout of the selected resource according to the quick access request when the authentication is passed; and transmitting a plurality of quick access responses with the selected resource and the file layout in parallel to the remote resource sharing apparatus via the network interface according to the share link, the at least one temporary share link and the at least one port number.

In addition to the aforesaid steps, the resource sharing method of the present invention can also execute all the operations described in all the aforesaid embodiments and have all the corresponding functions. How this embodiment executes these operations and has these functions will be readily appreciated by those of ordinary skill in the art based on the disclosures of all the aforesaid embodiments, and thus will not be further described again.

The resource sharing method described in this embodiment may be implemented by a federated resource sharing program having a plurality of codes. The federated resource sharing program is a computer program product that can be stored in a non-transitory computer readable storage medium. When the codes are loaded into an electronic device (e.g., the resource sharing apparatus RSA1 in the first to fifth embodiments and the mobile phone 61 in the sixth embodiment) and installed in the management system (e.g., the MS1 in the aforesaid embodiments) thereof, the computer program executes the resource sharing method as described in this embodiment. The non-transitory computer readable storage medium may be an electronic product, such as a read only memory (ROM), a flash memory, a floppy disk, a hard disk, a compact disk (CD), a mobile disk, a magnetic tape, a database accessible to networks, or any other storage media with the same function and well known to those skilled in the art.

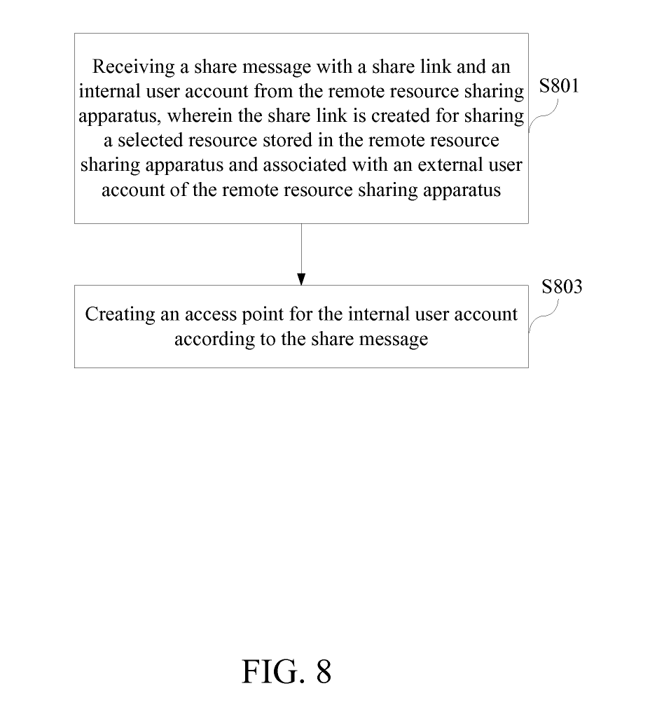

The eighth embodiment of the present invention is a resource sharing method, a flow chart of which is shown in FIG. 8. The resource sharing method is for use in a resource sharing apparatus (e.g., the resource sharing apparatus RSA2 in the first to fifth embodiments and the smart refrigerator 63 in the sixth embodiment). The resource sharing apparatus comprises a storage medium, a network interface and a processor. The storage medium stores a management system, and the processor runs a federated resource sharing program installed in the management system to execute the resource sharing method.

Firstly, step S801 is executed to receive a share message with a share link and an internal user account from the remote resource sharing apparatus. Specifically, the share link is created for sharing a selected resource stored in the remote resource sharing apparatus and associated with an external user account of the remote resource sharing apparatus. Next, step S803 is executed to create an access point for the internal user account according to the share message.

In other embodiments, the share message further includes the access permission information, and the shark link is further encrypted by a passkey. Therefore, the resource sharing method further comprises the following step of: decrypting the share link by a corresponding passkey. Besides, in other embodiments, the resource sharing method further comprises the following steps of: transmitting an access request to the remote resource sharing apparatus via the network interface to access the share link; and receiving a resource access response from the remote resource sharing apparatus.

Additionally, in another embodiment, the resource sharing method further comprises the following steps of: transmitting a quick access request to the remote resource sharing apparatus via the network interface to access the share link for downloading the selected resource, wherein the quick access request includes at least one temporary share link and at least one corresponding port number; and receiving a plurality of quick access responses with the selected resource and a file layout in parallel from the remote resource sharing apparatus via the network interface according to the share link, the at least one temporary share link and the at least one port number.

In addition to the aforesaid steps, the resource sharing method of the present invention can also execute all the operations described in all the aforesaid embodiments and have all the corresponding functions. How this embodiment executes these operations and has these functions will be readily appreciated by those of ordinary skill in the art based on the disclosures of all the aforesaid embodiments, and thus will not be further described again.

The resource sharing method described in this embodiment may be implemented by a federated resource sharing program having a plurality of codes. The federated resource sharing program is a computer program product that can be stored in a non-transitory computer readable storage medium. When the codes are loaded into an electronic device (e.g., the resource sharing apparatus RSA2 in the first to fifth embodiments and the smart refrigerator 63 in the sixth embodiment) and installed in the management system thereof, the computer program executes the resource sharing method as described in this embodiment. The non-transitory computer readable storage medium may be an electronic product, such as a read only memory (ROM), a flash memory, a floppy disk, a hard disk, a compact disk (CD), a mobile disk, a magnetic tape, a database accessible to networks, or any other storage media with the same function and well known to those skilled in the art.

According to the above descriptions, the resource sharing mechanism of the present invention allows different resource sharing apparatus to access resources of each other via the share links. In addition, resources transferring between the different resource sharing apparatus can be achieved via the share links, and the transmission time can be further shortened by parallel transmission via multiple share links (including at least one temporary share link) and their corresponding port numbers. Accordingly, through the resource sharing mechanism of the present invention, resources of different cloud storage systems are accessible to each other to allow users to share the resources of different cloud storage systems in a more convenient way, and make more efficient use of the resources of these cloud storage systems.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A resource sharing apparatus, comprising:
a storage medium, being configured to store a management system and a plurality of resources;
a network interface connected to a network; and
a processor, being electrically connected to the storage medium and the network interface, and configured to run a federated resource sharing program installed in the management system, the federated resource sharing program being configured to: receive a share request associated with an internal user account of the resource sharing apparatus for sharing a selected resource of the resources with an external user account of a remote resource sharing apparatus; create a share link of the selected resource according to the share request; generate a share message with the share link and the external user account; and transmit the share message to the remote resource sharing apparatus via the network interface so that the remote resource sharing apparatus creates an access point for the external user account according to the share message.

2. The resource sharing apparatus as claimed in claim 1, wherein the share request further includes access permission information, and the federated resource sharing program is further configured to: create the share link according to the access permission information; encrypt the share link by a passkey; and generate the share message with the encrypted share link and the access permission information.

3. The resource sharing apparatus as claimed in claim 2, wherein the federated resource sharing program is further configured to: create a share record in a database installed in the management system to record a link value of the share link, an index of the selected resource, the access permission information, and the passkey; and create the share link according to the share record.

4. The resource sharing apparatus as claimed in claim 3, wherein the federated resource sharing program is further configured to: create a group containing the external user account; and record the group in the share record.

5. The resource sharing apparatus as claimed in claim 1, wherein the federated resource sharing program is further configured to: receive an access request from the remote resource sharing apparatus via the network interface to access the share link; determine whether an authentication of the access request is passed; access the selected resource when the authentication is passed; and transmit a resource access response to the remote resource sharing apparatus.

6. The resource sharing apparatus as claimed in claim 1, wherein the federated resource sharing program is further configured to receive a quick access request from the remote resource sharing apparatus via the network interface to access the share link for downloading the selected resource, wherein the quick access request includes at least one temporary share link and at least one corresponding port number; determine whether an authentication of the quick access request is passed; create a file layout of the selected resource according to the quick access request when the authentication is passed; and transmit a plurality of quick access response with the file layout and the selected resource in parallel to the remote resource sharing apparatus via the network interface according to the share link, the at least one temporary share link and the at least one port number.

7. A resource sharing method for use in a resource sharing apparatus, the resource sharing apparatus comprising a storage medium, a network interface and a processor, the storage medium storing a management system and a plurality of resource, the processor running a federated resource sharing program installed in the management system to execute the resource sharing method, the resource sharing method comprising:
receiving a share request associated with an internal user account of the resource sharing apparatus for sharing a selected resource of the resources with an external user account of a remote resource sharing apparatus;
creating a share link of the selected resource according to the share request;
generating a share message with the share link and the external user account; and
transmitting the share message to the remote resource sharing apparatus via the network interface so that the remote resource sharing apparatus creates an access point for the external user account according to the share message.

8. The resource sharing method as claimed in claim 7, wherein the share request further includes access permission information, and the resource sharing method further comprising:
creating the share link according the access permission information;
encrypting the share link by a passkey; and
generating the share message with the encrypted share link and the access permission information.

9. The resource sharing method as claimed in claim 8, further comprising:
creating a share record in a database installed in the management system to record a link value of the share link, an index of the selected resource, the access permission information, and the passkey; and
creating the share link according to the share record.

10. The resource sharing method as claimed in claim 9, further comprising:
creating a group containing the external user account; and
recording the group in the share record.

11. The resource sharing method as claimed in claim 7, further comprising:
receiving an access request from the remote resource sharing apparatus via the network interface to access the share link;
determining whether an authentication of the access request is passed;
accessing the selected resource when the authentication is passed; and
transmitting a resource access response to the remote resource sharing apparatus.

12. The resource sharing method as claimed in claim 7, further comprising:
receiving a quick access request from the remote resource sharing apparatus via the network interface to access the share link for downloading the selected resource, wherein the quick access request includes at least one temporary share link and at least one corresponding port number;
determining whether an authentication of the quick access request is passed;
creating a file layout of the selected resource according to the quick access request when the authentication is passed; and
transmitting a plurality of quick access responses with the file layout and the selected resource in parallel to the remote resource sharing apparatus via the network interface according to the share link, the at least one temporary share link and the at least one port number.

13. A non-transitory computer readable storage medium, having a federated resource sharing program stored therein, the federated resource sharing program executing a resource sharing method after being loaded into a resource sharing apparatus and installed in a management system of the resource sharing apparatus, the resource sharing apparatus being connected to a network, the resource sharing method comprising:
receiving a share request associated with an internal user account of the resource sharing apparatus for sharing a selected resource of the resources with an external user account of a remote resource sharing apparatus;
creating a share link of the selected resource according to the share request;
generating a share message with the share link and the external user account; and
transmitting the share message to the remote resource sharing apparatus via the network interface so that the remote resource sharing apparatus creates an access point for the external user account according to the share message.

14. A resource sharing apparatus, comprising:
a storage medium, being configured to store a management system;
a network interface connected to a network; and
a processor, being electrically connected to the storage medium and the network interface, and configured to run a federated resource sharing program installed in the management system, the federated resource sharing program being configured to: receive a share message with a share link and an internal user account from the remote resource sharing apparatus, wherein the share link is created for sharing a selected resource stored in the remote resource sharing apparatus and associated with an external user account of the remote resource sharing apparatus; and create an access point for the internal user account according to the share message.

15. The resource sharing apparatus as claimed in claim 14, wherein the share message further includes the access permission information, the shark link is further encrypted by a passkey, and the federated resource sharing program is further configured to decrypt the share link by a corresponding passkey.

16. The resource sharing apparatus as claimed in claim 14, wherein the federated resource sharing program is further configured to transmit an access request to the remote resource sharing apparatus via the network interface to access the share link; and receive a resource access response from the remote resource sharing apparatus.

17. The resource sharing apparatus as claimed in claim 14, wherein the federated resource sharing program is further configured to transmit a quick access request to the remote resource sharing apparatus via the network interface to access the share link for downloading the selected resource, wherein the quick access request includes at least one temporary share link and at least one corresponding port number; and receive a plurality of quick access responses with a file layout the selected resource in parallel from the remote resource sharing apparatus via the network interface according to the share link, the at least one temporary share link and the at least one port number.

18. A resource sharing method for use in a resource sharing apparatus, the resource sharing apparatus comprising a storage medium, a network interface and a processor, the storage medium storing a management system, the processor running a federated resource sharing program installed in the management system to execute the resource sharing method, the resource sharing method comprising:
receiving a share message with a share link and an internal user account from the remote resource sharing apparatus, wherein the share link is created for sharing a selected resource stored in the remote resource sharing apparatus and associated with an external user account of the remote resource sharing apparatus; and
creating an access point for the internal user account according to the share message.

19. The resource sharing method as claimed in claim 18, wherein the share message further includes the access permission information, the shark link is further encrypted by a passkey, and the resource sharing method further comprising:
decrypting the share link by a corresponding passkey.

20. The resource sharing method as claimed in claim 18, further comprising:
transmitting an access request to the remote resource sharing apparatus via the network interface to access the share link; and
receiving a resource access response from the remote resource sharing apparatus.

21. The resource sharing method as claimed in claim 18, further comprising:
transmitting a quick access request to the remote resource sharing apparatus via the network interface to access the share link for downloading the selected resource, wherein the quick access request includes at least one temporary share link and at least one corresponding port number; and
receiving a plurality of quick access responses with a file layout the selected resource in parallel from the remote resource sharing apparatus via the network interface according to the share link, the at least one temporary share link and the at least one port number.

22. A non-transitory computer readable storage medium, having a federated resource sharing program stored therein, the federated resource sharing program executing a resource sharing method after being loaded into a resource sharing apparatus and installed in a management system of the resource sharing apparatus, the resource sharing apparatus being connected to a network, the resource sharing method comprising:
receiving a share message with a share link and an internal user account from the remote resource sharing apparatus, wherein the share link is created for sharing a selected resource stored in the remote resource sharing apparatus and associated with an external user account of the remote resource sharing apparatus; and
creating an access point for the internal user account according to the share message.
